(19) United States
(12) Patent Application Publication
(10) Pub. No.: US 2022/0398822 A1
(43) Pub. Date: Dec. 15, 2022

(54) SYSTEMS AND METHODS FOR COMMUNICATING AN IMAGE TO THE VISUALLY IMPAIRED

(71) Applicant: Meta Platforms, Inc., Menlo Park, CA (US)

(72) Inventors: Shaomei Wu, Mountain View, CA (US); Tatiana Iskandar, San Mateo, CA (US); Dennis Stewart William Tansley, Morgan Hill, CA (US); Jerry Guanhua Qian, Mountain View, CA (US); Isaac Robinson, New York, NY (US); Jerry L. Robinson, Fremont, CA (US); Madhavi Marigold Muppala, Menlo Park, CA (US)

(21) Appl. No.: 17/732,149

(22) Filed: Apr. 28, 2022

Related U.S. Application Data
(60) Provisional application No. 63/209,068, filed on Jun. 10, 2021.

(51) Int. Cl. G06V 10/22; G06V 10/74; G06V 20/64

(52) U.S. Cl. CPC G06V 10/235; G06V 10/761; G06V 20/64

(57) ABSTRACT

The present application is at least directed to a system including a processor and non-transitory memory including computer-executable instructions, which when executed by the processor, perform receiving, via a user operating the system, a selection of a mode for recognizing objects. The processor is also configured to execute the instructions of causing a camera operably coupled to the system to operate in the selected mode for recognizing objects. The processor is further configured to execute the instructions of receiving, via the user operating the system, an image of a selected object. The processor is even further configured to execute the instructions of evaluating, via a trained machine learning model, one or more attributes of the selected object. The processor is yet further configured to execute the instructions of generating an image description based on at least a subset of the evaluated one or more attributes. The processor is yet even further configured to execute the instructions of communicating the generated image description to the user via a user interface.

### CROSS-REFERENCE TO RELATED APPLICATION

This application claims priority to U.S. Provisional Application No. 63/209,068, filed Jun. 10, 2021, which is incorporated by reference herein in its entirety.

### FIELD

The present application is directed to systems and methods for recognizing an image and/or video(s) and communicating it to the visually impaired. More particularly, the present application is directed to systems and methods of recognizing one or more objects and communicating object(s) attributes to the visually impaired.

### BACKGROUND

Vision is a right enjoyed by much of the world's population. Sometimes, however, this right is taken for granted by those without visual impairments.

For those who are visually impaired, the idea of autonomously selecting objects simply is a fantasy. For example, visually impaired individuals may not have access to someone in their home or close by to help select an object. And if someone is accessible, they may not be available at the exact time when the visually impaired individual requires assistance.

In view of the foregoing, there may be a need for a software application operable on a computing device that provides users with the ability to identify and select objects in real-time. There may also be a need for a software application operable on a computing device that provides users with accurate attributes of the object to improve decision-making.

### SUMMARY

This summary is provided to introduce a selection of concepts in a simplified form that are further described below in the Detailed Description. This Summary is not intended to limit the scope of the claimed subject matter. The foregoing needs are met, to a great extent, by the present application described in more detail below.

In one aspect of the application, there is described a system including a non-transitory memory including instructions stored thereon and a processor operably coupled to the non-transitory memory configured to execute a set of instructions. The instructions to be executed include receiving, via a user operating a computing device, a selection of a mode for recognizing an object. The instructions include causing a camera associated with the computing device to operate in the selected mode for recognizing the object. The instructions also include receiving, via the user operating the computing device, an image of a selected object. The instructions further include evaluating, via a trained machine learning model, one or more attributes of the selected object. The instructions yet further include generating an image description based on at least a subset of the evaluated one or more attributes. The instructions yet even further include communicating the generated image description to the user via a user interface of the computing device.

In another aspect of the application, there is described a computer-implemented method for identifying an object and communicating its attributes to a user. The computer-implemented method includes receiving a selection of a mode for recognizing objects. The computer-implemented method also includes receiving an image of a selected object captured via a camera of a computing device in response to the selection of the mode for recognizing object. The computer-implemented method further includes evaluating, via a trained machine learning model, one or more attributes of the selected object. The computer-implemented method even further includes generating an image description based on at least a subset of the evaluated one or more attributes. The computer-implemented method yet even further includes communicating the generated image description to the user via a user interface of the computing device.

There has thus been outlined, rather broadly, certain embodiments of the invention in order that the detailed description thereof may be better understood, and in order that the present contribution to the art may be better appreciated.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 illustrates a block diagram of an example user equipment device according to an aspect of the application.

FIG. 2 is a block diagram of an example computing system according to an aspect of the application.

FIG. 3 illustrates a machine learning model communicating with stored training data.

FIG. 4 illustrates a clothing recognition option of a camera according to an embodiment.

FIGS. 5A-C illustrate a sequence of steps for identifying attributes associated with an object, such as for example a garment, according to an exemplary embodiment.

FIGS. 6A-C illustrate a sequence of steps for identifying attributes associated with an object, such as for example a garment, according to another exemplary embodiment.

FIG. 7 illustrates another use of the system for identifying text of an object according to an exemplary embodiment.

FIG. 8 illustrates a flowchart according to an exemplary aspect of the application.

### DETAILED DESCRIPTION OF THE ILLUSTRATIVE EMBODIMENTS

A detailed description of the illustrative embodiment will be discussed in reference to various figures, embodiments, and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “an aspect” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other. While the object indicated in aspects of the application may reference a garment in certain exemplary embodiments, the scope of the present application is not limited to this specific exemplary embodiment.

Generally, the present application enables visually impaired individuals with assistance to identify images/videos or objects of interest. In particular, the present application describes software applications operable on user equipment (UE) to help users determine attributes of a object. In an embodiment, the object may be a garment. Doing so allows visually impaired individuals the autonomy to select and customize their wardrobe without requiring another individual to describe a garment to the visually impaired individual(s).

One aspect to achieve the above-mentioned results includes a computing device configured to execute a set of instructions. In an exemplary embodiment, the instructions to be executed include receiving, via a user operating the system, a selection of a mode for recognizing objects, such as for example garments. The instructions include causing a camera operably coupled to the computing device to operate in the selected mode for recognizing garments. The instructions also include receiving, via the user operating the computing device, an image of a selected garment. The instructions further include evaluating, via a trained machine learning model, one or more attributes of the selected garment. In an exemplary embodiment, the one or more attributes may include color, size, shape, texture, pattern, print and any other suitable attributes. In another exemplary embodiment, the evaluation performed by the computing device may include assigning each of the one or more attributes a score based upon a likelihood of similarity with at least one respective attribute present in training data.

The evaluation may also include filtering the assigned one or more attributes based on predetermined criteria. The evaluation may include outputting one or more filtered attributes meeting the predetermined criteria. The instructions may yet further include generating an image description based on at least a subset of the evaluated one or more attributes. According to another exemplary embodiment, the generated image description may be located at least partially within a bounding box. Additionally, the selected garment may be at least partially located in the bounding box.

The instructions may even further include communicating the generated image description to the user. In an exemplary embodiment, a user interface of a computing device may present the communication of the generated image description to the user. The communication of the generated image description to the user may be via voice, text, or vibration.

According to yet even another embodiment, the user may wish to obtain additional information beyond what was communicated in the first image description. Here, the processor of the computing device may be further configured to execute the instructions of receiving a user request for additional information of the selected object. The object may be a garment. Moreover, the processor is further configured to execute the instructions of determining, via the trained machine model, the one or more attributes of the selected garment not previously communicated to the user. Further, the processor is further configured to execute the instructions of generating another image description based upon the determination, and communicating the other image description to the user.

According to the present application, it is understood that any or all of the systems, methods and processes described herein may be embodied in the form of computer executable instructions, e.g., program code, stored on a computer-readable storage medium which instructions, when executed by a machine, such as a computer, server, transit device or the like, perform and/or implement the systems, methods and processes described herein. Specifically, any of the steps, operations or functions described above may be implemented in the form of such computer executable instructions. Computer readable storage media includes volatile and nonvolatile, removable, and non-removable media implemented in any method or technology for storage of information, but such computer readable storage media do not include signals. Computer readable storage media may include, but are not limited to, random access memory (RAM), read only memory (ROM), electrically erasable programmable read-only memory (EEPROM), flash memory or other memory technology, compact disc read only memory (CD ROM), digital versatile disks (DVD) or other optical disk storage, magnetic cassettes, magnetic tape, magnetic disk storage or other magnetic storage devices, or any other physical medium which can be used to store the desired information and which may be accessed by a computer.

Particular aspects of the invention will be described in more detail below.

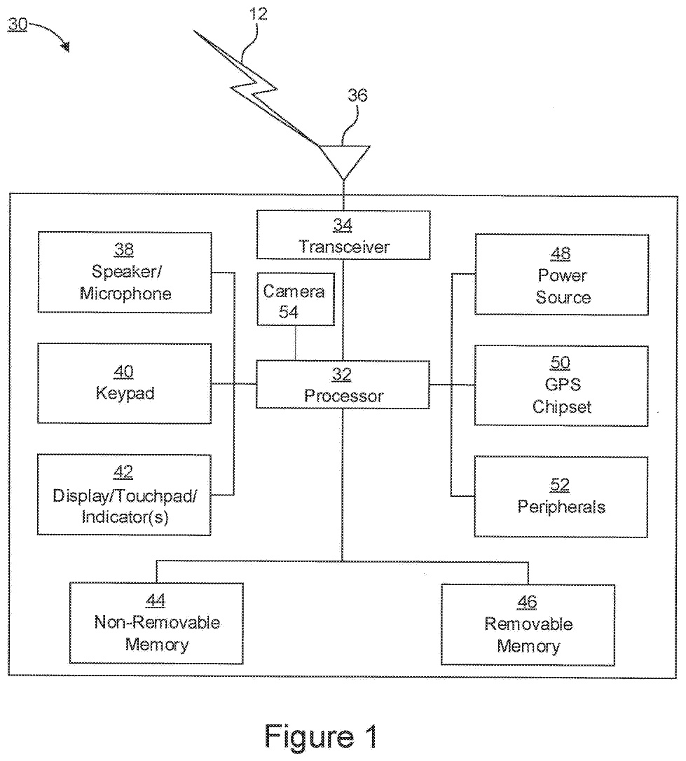

FIG. 1 is a block diagram of an exemplary hardware/software architecture of a UE 30. As shown in FIG. 1, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an exemplary embodiment, the camera 54 is a smart camera configured to sense images appearing within one or more bounding boxes. In an exemplary embodiment, the images may include garments and/or objects (e.g., parcels) of textual indicia. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a general purpose processor, a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

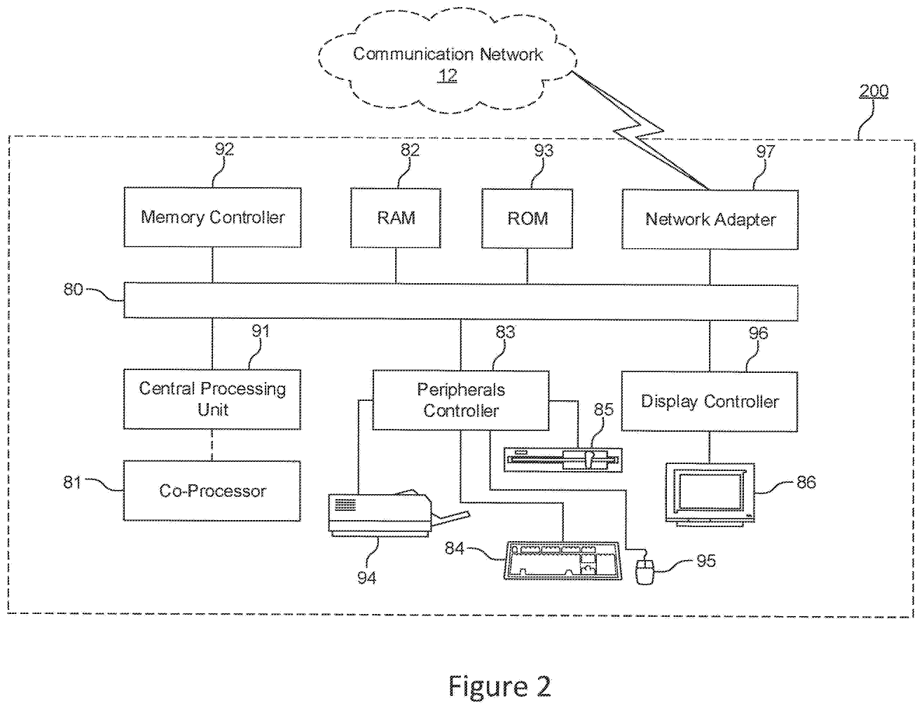

FIG. 2 is a block diagram of an exemplary computing system 200 which may also be used to implement components of the system or be part of the UE 30. The computing system 200 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 200 to operate. In many known workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 200 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 200 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 200. Such visual output may include text, graphics, animated graphics, and video. Display 86 may be implemented with a cathode-ray tube (CRT)-based video display, an liquid-crystal display (LCD)-based flat-panel display, gas plasma-based flat-panel display, or a touch-panel. Display controller 96 includes electronic components required to generate a video signal that is sent to display 86.

Further, computing system 200 may contain communication circuitry, such as for example a network adaptor 97, that may be used to connect computing system 200 to an external communications network, such as network 12 of FIG. 1, to enable the computing system 200 to communicate with other nodes (e.g., UE 30) of the network.

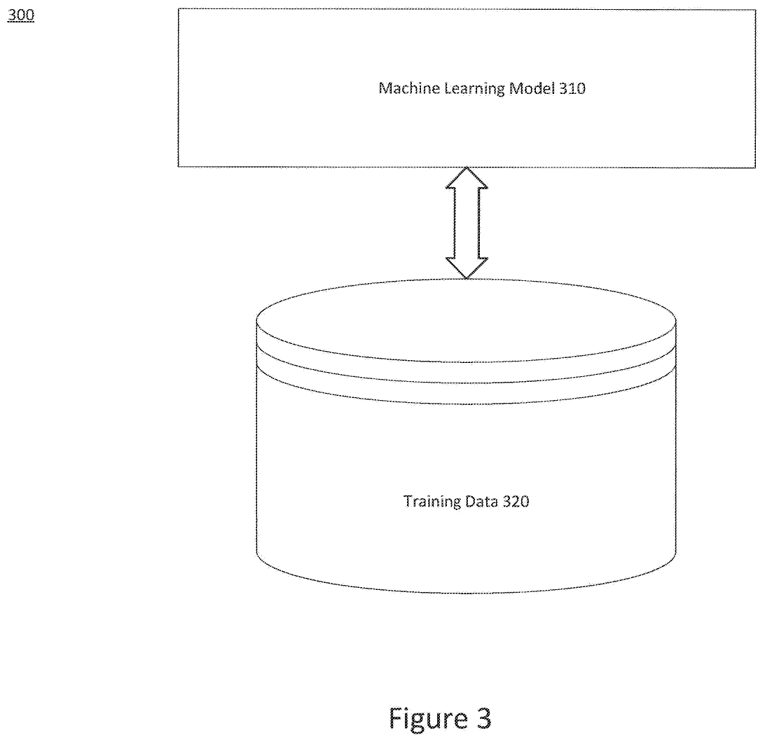

FIG. 3 illustrates a framework 300 employed by a software application (e.g., algorithm) for evaluating attributes of a selected garment. The framework 300 may be hosted remotely. Alternatively, the framework 300 may reside within the UE 30 shown in FIG. 1 and/or be processed by the computing system 200 shown in FIG. 2. The machine learning model 310 is operably coupled to the stored training data in a database 320.

In an exemplary embodiment, the training data 320 may include attributes of thousands of objects. For example the object may be a garment. Attributes may include but are not limited to the color, size, shape, text, patterns of a garment(s). A non-exclusive list of garments may include shirts, pants, dresses, suits, and accessories such as belts, ties, scarves, hats, and shoes. The training data 320 employed by the machine learning model 310 may be fixed or updated periodically. Alternatively, the training data 320 may be updated in real-time based upon the evaluations performed by the machine learning model 310 in a non-training mode. This is illustrated by the double-sided arrow connecting the machine learning model 310 and stored training data 320.

In operation, the machine learning model 310 may evaluate attributes of images/videos obtained by hardware of the UE. Namely, the camera 54 of the UE 30 shown in FIG. 1 senses and captures an image/video, such as for example garments and/or other objects (e.g., textual indicial of parcels), appearing in or around a bounding box of the software application. The attributes of the captured image are then compared with respective attributes of stored training data 320. The likelihood of similarity between each of the obtained attributes and the stored training data 320 is given a confidence score. In one exemplary embodiment, if the confidence score exceeds a predetermined threshold, the attribute is included in an image description that is ultimately communicated to the user via a user interface of a computing device (e.g., UE 30). In another exemplary embodiment, the description may include a certain number of attributes which exceed a predetermined threshold to share with the user. The sensitivity of sharing more or less attributes can be customized based upon the needs of the particular user.

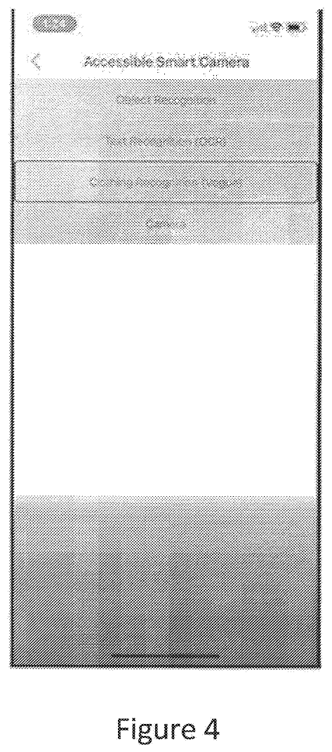

FIG. 4 illustrates a user interface of UE 30 including plural options for capturing images by the camera 54. The options may include Object Recognition, Text Recognition (OCR), Clothing Recognition (Vogue) and Camera. According to the exemplary embodiment in FIG. 4, the option for Clothing Recognition (Vogue) is shown as being selected by a user depicted by the box surrounding.

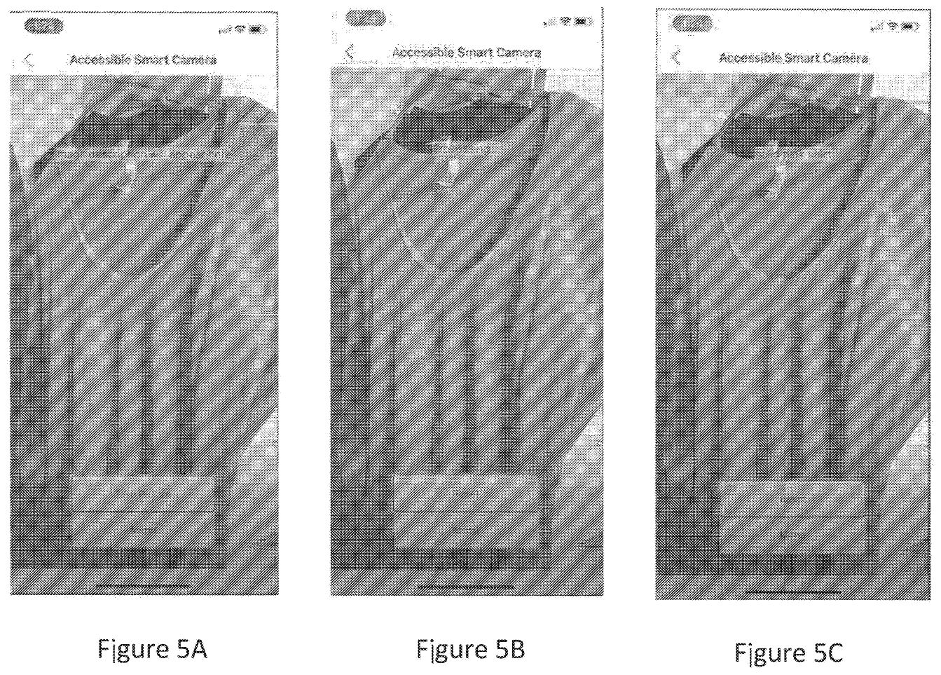

In the exemplary embodiments described below with respect to FIGS. 5A-5C, FIGS. 6A-6C and FIG. 7, the user may be visually impaired (e.g., blind, colorblind, etc.).

FIGS. 5A-5C show a particular sequence of processing steps performed by the software application for providing descriptions of objects. For example, the object may be a garment. Namely, the user may hold the (UE 30) and move through the location of interest including garments. In the exemplary embodiment of FIG. 5A, the user is prompted to take a picture once the software application recognizes a garment in or around the garment box. If a garment does not appear, the software application may inform the user of an error. If the garment is partially recognized but cannot be sufficiently read to perform an evaluation, the user may be prompted either via voice, text, and/or vibration to move the UE 30 in a certain direction. In FIG. 5A, a box indicating “image description will appear here” appears on or around the image of the garment. This box appears prior to the user selecting the ‘Take Picture’ option.

Upon the user taking/capturing the picture via camera 54, FIG. 5B illustrates an updated image on the user interface with a box indicating ‘Processing’ on or around the image of the garment. Here, the software application may perform the evaluation in view of the machine learning model.

Next, FIG. 5C illustrates the results of the evaluation via a further updated image. This may include generating an image description based on at least a subset of the evaluated one or more attributes in view predetermined criteria. In an exemplary embodiment, a bounding box appears at least partially including the garment. Inside the bounding box, as well as on or around the garment, a description of the garment is communicated to the user via the user interface. Here, the image description indicates “Solid Pink Shirt.” The communication may be provided via voice, text, and/or vibration.

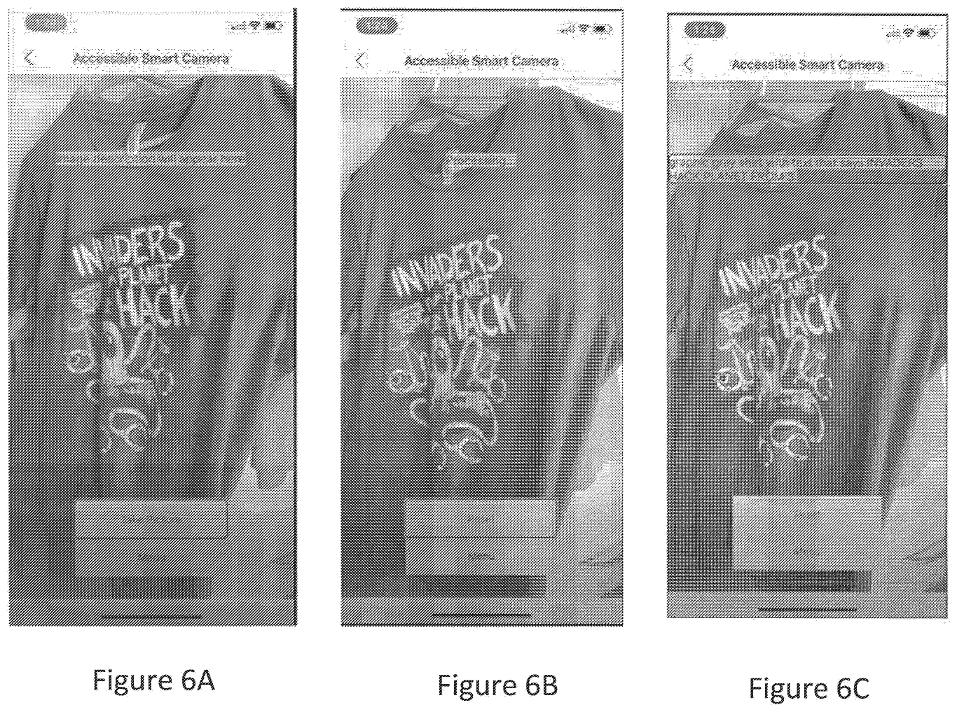

FIGS. 6A-6C illustrate another exemplary embodiment for recognizing attributes of a garment and communicating the attributes to a user. Here, the garment is a shirt with graphics and text. Similar to FIGS. 5A-5C, once processing has been completed via the evaluation step in view of the machine learning model. FIG. 5C illustrates the image description on or around the garment and at least within the bounding box. Here, the image description states, “Graphic gray shirt with text that says INVADERS HACK PLANET FROM 3.”

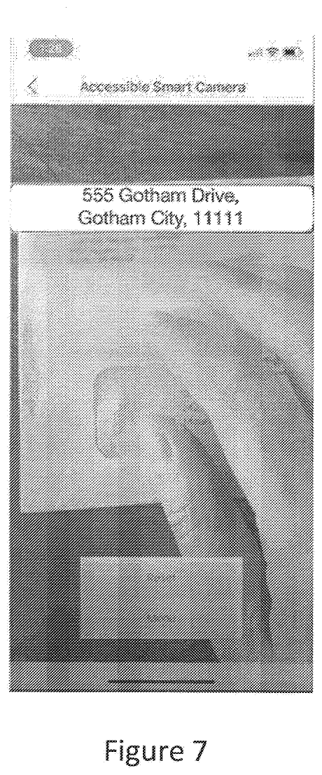

FIG. 7 illustrates an alternative exemplary embodiment of the present application. Here, text of an object such as for example the sender of a parcel (e.g., mail) may be captured by the camera 54 of UE 30 when the user points the camera 54 at the parcel and takes/captures an image. The textual indicia of the parcel may be communicated to the user via the user interface of the UE. In the example of FIG. 7, the textual indicia may be, for example, 555 Gotham Drive, Gotham City 11111. In one exemplary embodiment, the UE 30 may be configured to recognize textual indicia of objects in response to the user selecting the text recognition (OCR) option of the user interface shown in FIG. 4. While the camera 54 of the UE 30 captured an image of a parcel in the example of FIG. 4 and recognized the textual indicia for presentation to the user, it should be pointed out that the camera 54 may also be configured to capture textual indicial of any other suitable object of an image/video for presentation to the user without departing from the spirit and scope of the invention.

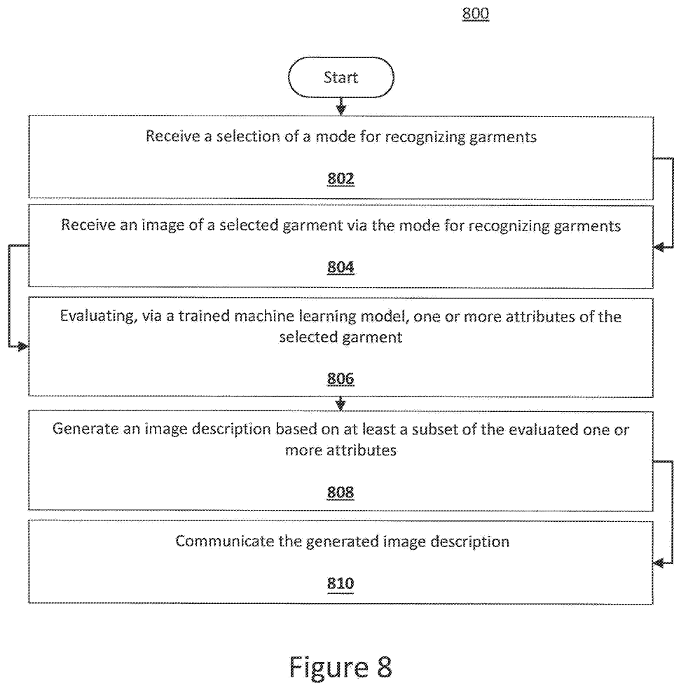

FIG. 8 illustrates a flowchart 800 according to an exemplary aspect of the application. The flowchart 800 may include a set of steps 802, 804, 806, 808, and 810. In an embodiment, the steps may be performed by a computing device (e.g., UE 30). In another embodiment, the steps may be configured as set of program instructions stored in a non-transitory memory of a computer readable medium (CRM) executable by a processor (e.g., processor 32, co-processor 81, etc.). Specifically, step 802 includes receiving a selection of a mode for recognizing objects, such as for example, garments. Step 804 includes receiving an image of a selected garment via the mode for recognizing garments. Step 806 includes evaluating, via a trained machine learning model, one or more attributes of the selected garment. Step 808 includes generating an image description based on at least a subset of the evaluated one or more attributes. Step 810 includes communicating the generated image description to a user via a user interface. The user may be visually impaired. Presentation of the generated image description to the user enables the user autonomy to select and customize a wardrobe of garments without another individual describing garments to the user.

While the systems and methods have been described in terms of what are presently considered to be specific aspects, the application need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed is:

1. A system comprising a processor and a non-transitory memory including computer-executable instructions which, when executed by the processor, effectuate:
receiving, via a user operating a computing device, a selection of a mode for recognizing objects;
causing a camera associated with the computing device to operate in the selected mode for recognizing the objects;
receiving, via the user operating the computing device, an image of a selected object captured by the camera;
evaluating, via a trained machine learning model, one or more attributes of the selected object;
generating an image description based on at least a subset of the evaluated one or more attributes; and
communicating the generated image description to the user via a user interface of the computing device.

2. The system of claim 1, wherein the object is a garment, and the one or more attributes comprise color, size, shape, texture, pattern or print.

3. The system of claim 1, wherein the evaluation comprises assigning each of the one or more attributes a score based upon a likelihood of similarity with at least one respective attribute indicated in training data.

4. The system of claim 3, wherein the evaluation comprises filtering the assigned one or more attributes based on predetermined criteria.

5. The system of claim 4, wherein the evaluation comprises outputting one or more filtered attributes meeting the predetermined criteria.

6. The system of claim 1, wherein the generated image description is located within a bounding box of the user interface.

7. The system of claim 6, wherein the selected object is partially located in the bounding box of the user interface.

8. The system of claim 1, wherein the processor is further configured to execute the computer-executable instructions of:
receiving a user request for additional information of the selected object; and
determining, via the trained machine model, the one or more attributes of the selected object not previously communicated to the user;
generating another image description based upon the determination; and
communicating the other image description to the user via the user interface.

9. The system of claim 8, wherein the communication is via voice, text or vibration.

10. A computer-implemented method comprising:
receiving, via a user interface, a selection of a mode for recognizing objects;
receiving an image of a selected objects captured by a camera in response to selection of the mode for recognizing objects;
evaluating, via a trained machine learning model, one or more attributes of the selected object;
generating an image description based on at least a subset of the evaluated one or more attributes; and
communicating the generated image description to a user interface of a computing device.
